(19) United States
(12) Patent Application Publication
(10) Pub. No.: US 2014/0341634 A1
(43) Pub. Date: Nov. 20, 2014

(54) ANCHOR POINT IN A MOTOR VEHICLE

(71) Applicants: Andrew Chatwin, Stratford Upon Avon (GB); Mark Collins, Warwick (GB)

(72) Inventors: Andrew Chatwin, Stratford Upon Avon (GB); Mark Collins, Warwick (GB)

(73) Assignee: JAGUAR LAND ROVER LIMITED, Whitley Coventry Warwickshire (GB)

(21) Appl. No.: 14/344,535

(22) PCT Filed: Sep. 12, 2012
(86) PCT No.: PCT/EP2012/067832

§ 371 Date: Jun. 4, 2014

(30) Foreign Application Priority Data
Sep. 12, 2011 (GB) 1115749.2

(51) Int. Cl. B60R 11/00; F16B 21/09

(52) U.S. Cl. CPC B60R 11/00; F16B 21/09; B60R 2011/0061
USPC 403/11; 29/428; 403/322.1

(57) ABSTRACT

A motor vehicle having a cabin for one or more occupants, one said one or more occupants being a driver of the vehicle, the cabin comprising: at feast one anchor point for supporting an accessory, the anchor point comprising a receiver for receiving a corresponding adaptor of an accessory, the receiver comprising a locking means whereby an adaptor may be releasably locked to the receiver such that when in the coupled condition separation of an adaptor and the receiver is resisted unless an adaptor is first unlocked from the receiver.

### FIELD OF THE INVENTION

The present invention relates to anchor points for anchoring an article at a location, in particular but not exclusively the invention relates to motor vehicles and to a method of anchoring accessories in a motor vehicle. Aspects of the invention relate to an apparatus, to an accessory, to an anchor point, to a method and to a vehicle.

### BACKGROUND

It is known to provide anchor points at fixed locations in a cabin environment of a motor vehicle for attachment of components such as seats. The anchor points are in the form of tapped apertures that are formed either directly in a structural member of the vehicle or in a mounting bracket that is attached to a structural member.

Anchor points such as D-loops for securing cargo tie-downs may be mounted in a vehicle payload area such as a boot or trunk of the vehicle. The D-loops are typically bolted or welded to a structural member in the payload area.

In some known arrangements, anchor points for tie-downs and the like are provided in the form of eyes that are slidable along a fixed rail to a required position, which may depend on the size or shape of a load to be secured.

If a vehicle owner wishes to install an accessory in the vehicle, it is typically necessary to install fixings for the accessory. Installation may therefore require the step of forming holes in one or more trim panels of the cabin in order to attach the fixing. It may also be necessary to form holes in one or more structural members of the vehicle.

If the accessory is subsequently removed, holes drilled in trim panels are exposed and are unsightly, reducing the resale value of the vehicle.

### STATEMENT OF THE INVENTION

Embodiments of the invention may be understood with reference to the appended claims.

According to one aspect of the invention there is provided a motor vehicle having a cabin for one or mere occupants, the cabin comprising: at least one anchor point for supporting an accessory, the anchor point comprising a receiver for receiving a corresponding adaptor of an accessory; and an accessory having an adaptor arranged to couple the accessory to the receiver, the accessory and receiver comprising a locking means whereby the adaptor may be releasably locked to the receiver such that when in the coupled condition separation of the adaptor and the receiver is resisted unless the adaptor is first unlocked from the receiver. The locking means comprises a cam arrangement, the earn arrangement comprising: a follower portion and a cam portion, the cam portion being arranged to engage the follower portion when the adaptor is locked to the receiver. The locking means further comprises a resilient member fixedly attached to the adapter or receiver, the resilient member being arranged to urge the follower portion against the cam portion when the cam portion engages the follower portion.

According to a further aspect of the invention there is provided a motor vehicle having a cabin for one or more occupants, the cabin comprising: at least one anchor point for supporting an accessory, the anchor point comprising a receiver for receiving a corresponding adaptor of an accessory; and an accessory having an adaptor arranged to couple the accessory to the receiver, the accessory and receiver comprising a locking means whereby the adaptor may be releasably locked to the receiver such that when in the coupled condition separation of an adaptor and the receiver is resisted unless the adaptor is first unlocked from the receiver. The locking means comprises a cam arrangement. The receiver is coupled to an electrical power supply, the receiver being arranged to form an electrical connection to a corresponding electrical conductor of the adaptor when an adaptor is coupled to the receiver wherein electrical power may be supplied by the receiver to an accessory.

According to a further aspect of the invention there is provided a motor vehicle having a cabin for one or more occupants, one of said one or more occupants being a driver of the vehicle, the cabin comprising: at least one anchor point for supporting an accessory, the anchor point comprising a receiver for receiving a corresponding adaptor of an accessory; and an accessory having an adaptor arranged to couple the accessory to the receiver. The accessory and receiver comprise a locking means whereby the adaptor may be releasably locked to the receiver such that when in the coupled condition separation of the adaptor and the receiver is resisted unless the adaptor is first unlocked from the receiver. The locking means comprises a cam arrangement.

It may be that the cam arrangement comprises: a follower portion and a cam portion, the cam portion being arranged to engage the follower portion when the adaptor is locked to the receiver. Where this is the case, it may he that the looking moans comprises a resilient member fixedly attached to the follower portion or the cam arrangement, the resilient member being arranged to urge the follower portion against the cam arrangement when the cam arrangement engages the follower portion.

If may he that the receiver is coupled to an electrical power supply, the receiver being arranged to form an electrical connection to a corresponding electrical conductor of the adaptor when an adaptor is coupled to the receiver wherein electrical power may be supplied by the receiver to an accessory.

It may be that one of said one or more occupants is a driver of the vehicle.

In any of the previous embodiments, it may be that the resilient member is a helical spring.

One said one or more occupants may he a driver of the vehicle.

Embodiments of the invention have the advantage that an accessory may be releasably but securely installed in a vehicle cabin without damaging or compromising an appearance of trim panels or trim features of the vehicle. This is because the receiver is already mounted in the vehicle ready to receive the adapter when required.

Embodiments of the invention have the advantage that a risk that an accessory inadvertently becomes detached from its anchor point is substantially eliminated. Thus, a risk that an accessory becomes detached due to mechanical vibration of the vehicle or tugging en the accessory is reduced.

A resilient member fixedly attached to the adaptor or the receiver can assist in making the locking means more secure. Fixedly attaching the resilient member can help to prevent it becoming detached, and also help to prevent the resilient member moving when the locking means is not locked, and so reduce the noise which might otherwise be made by the resilient member moving, for example in the form of rattling.

Advantageously the cabin may be provided with a plurality of receivers at different

respective locations configured to accept like adaptors.

This feature has the advantage that a user may configure the positions of accessories, of the vehicle according to the user's individual requirements or preferences.

Thus, an accessory in the form of a cup holder may be sited in a suitable location for one particular cabin occupant and at a later time a different position for a different cabin occupant. Similarly an accessory bearing a cradle for supporting a mobile telecommunications device or an accessory bearing a work surface for a computer, papers or other articles may be moved to different positions as required by a user. Thus flexible and intuitive reconfiguration of the cabin may be undertaken by a user as required, enhancing utility of the vehicle and a user's enjoyment of the vehicle.

The locking means comprises a cam or cam-like feature for effecting locking of the adaptor to the receiver.

The cam arrangement may form part of a cam-lock arrangement. For example a cam-lock arrangement of the type employed in quarter-turn fasteners or half-turn fasteners, for example Cam-Loc (TM) quarter-turn fasteners.

One of the adaptor and receiver is provided with a cam portion and the other one of the adaptor and receiver is provided with a corresponding follower portion. It may be that the locking means of the receiver comprises a follower portion arranged to engage a corresponding cam portion of locking means of the adaptor. It may be that the looking means of the adaptor comprises a follower portion arranged to engage a corresponding cam portion of a locking means of the receiver.

The follower portion may comprise a pin member.

Advantageously the cam arrangement may comprise a shaft member, the shaft member having one or more pin members protruding radially therefrom and arranged to engage the cam portion.

The cam portion may be provided by a earn receptacle arranged to engage the one or more pin members.

The adaptor may comprise a pair of pin members arranged to protrude radially from opposed sides of the shaft member.

The pin members may be provided by a single cross-pin disposed to pass through a centre of the shaft.

Where electrical power is supplied by the receiver to the accessory, this has the advantage that accessories requiring electrical power may he supplied with power via the anchor point, not requiring a separate, independent connection to be made to a power source.

Further advantageously the adaptor and receiver may be arranged to provide an electrical flowpath therethrough by means of which electrical current may flow from a power source of the vehicle to the accessory and back to the power source.

The shaft member may comprise an outer conductor and an inner conductor in electrical isolation from the outer conductor whereby the electrical flow path may be provided.

Thus one conductor may be arranged to be provided at an earth potential whilst the other is arranged to be provided at a positive or negative potential with respect to earth potential.

It may be that the receiver is electrically coupled to an electrical ground of the vehicle. Advantageously the outer conductor may be arranged to be electrically coupled to an electrical ground of the vehicle by means of the receiver.

In the case of a vehicle having a body portion at electrical earth potential, the outer conductor may be advantageously electrically coupled to the body portion. Further advantageously the electrical coupling to the body portion may be provided locally to the anchor point.

Advantageously, the vehicle may be configured wherein electrical power to the receiver is switched on when an adaptor is coupled to the receiver.

For example, in the case the adaptor is coupled to the receiver in a twisting action, the twisting action may actuate an electrical switch.

It may be that the adaptor is provided with an electrical conductor arranged to form an electrical connection to a receiver whereby electrical power may be supplied by a receiver to the accessory. If may further be that the adaptor is arranged to provide an electrical flowpath by means of which electrical current may flow from a power source through a receiver to the accessory and back to a power source via the receiver.

The vehicle may comprise one or more receivers of a first type and one or more receivers of a second type, a receiver of the first type being arranged to couple to a corresponding adaptor of a first type, a receiver of the second type being arranged to be coupled to a corresponding adaptor of the second type. If may be that a receiver of the first type is configured not to allow a coupling to be made to an adaptor of the second type. In other words, it may be that an adaptor for coupling to the second type of receiver is arranged not to couple to a receiver of the first type.

Optionally a receiver of the first type has a first load capacity and a receiver of the second type has a second load capacity greater than the first.

Receivers of the first type may be arranged to be frangible under excessive loading. Thus if en accessory is pulled or knocked harshly, the receiver may break thereby reducing a risk of damage to the accessory and/or injury to an occupant.

The second load capacity may correspond to a heavy duty load capacity and the first load capacity may correspond to a light duty load capacity.

Thus, in some embodiments accessories requiring a heavy duty anchor point such as cargo eyes, D-loops, folding bail accessories and the like may be arranged only to be capable of coupling to receivers of the second type.

In some arrangements receivers of the second type may receive adaptors of the first type. Thus, a mobile phone cradle or a cup holder arranged to be fitted to a receiver of the first type may in some arrangements be capable of coupling to a receiver of the second type.

This feature increases an extent to which a user may intuitively configure his or her vehicle according to their individual requirement at a given moment in time.

It may be that the one or more receivers of the first type are coupled to the electrical power supply.

In some embodiments an accessory may be provided in the form of a heated cup-holder. In some embodiments a refrigerated cup-holder is provided. In some embodiments a powered storage device may be provided which may be a thermal storage device (for example a refrigerator or other refrigerated storage device), an illuminated storage device and/or a motorised storage device or other motorised and/or illuminated accessory.

At present, one or more 12V sockets ere typically provided in a motor vehicle at one or more locations for providing electrical connections to an accessory such as a satellite navigation device, a mobile phone device or the like. If the accessory is to be supported in a fixed position at a given location, an additional support means must be provided such as a suction cup arranged to fee secured to a windscreen or other suitable fixing means.

Some known light-weight electrical accessories such as map-lights are arranged to be supported by the 12V socket itself. However such accessories suffer the disadvantage that they may inadvertently lose power due to the plug being knocked, tugged or otherwise displaced from a fully engaged condition with respect to the socket.

Advantageously the one or more receivers of the first type may be coupled to the electrical power supply.

The accessory may comprise one selected from amongst a cup holder, a light source, a D-loop, a folding D-loop, a cargo eye, a grab handle, a video display mount, a mount for a handheld electrical device and a storage module. The accessory may therefore comprise a fixing means, such as a mount, a D-loop, a holder such as a cup holder, an adhesive strip or the like.

In some embodiments, one or more receivers may be provided at locations external to the vehicle. The receivers may be arranged to receive corresponding accessories coupled to a winch, a roof-rack, a light, a scale or ladder, an exterior light, a towbar or the like.

In some arrangements, a receiver for supporting a relatively light load may be coupled to a trim panel of the vehicle. Receivers for supporting a relatively heavy load may be coupled to a structural member of the vehicle.

Optionally when the accessory is coupled to the receiver a watertight seal is formed therebetween. It may be that the receiver is provided with seal means whereby when file adaptor is coupled to the receiver a watertight seal may foe provided therebetween. It may be that the adaptor is provided with seal means whereby when the adaptor is coupled to the a watertight seal may be provided therebetween.

This feature has the advantage that in some embodiments a risk of short circuiting of an electrical connection between the accessory and receiver may be reduced, for example in the case of exposure to liquid such as due to spillage or introduction of rain into the vehicle cabin through an open door or window.

Advantageously a visual indicator may be provided to indicate when the accessory is correctly coupled to the receiver.

The indicator may be operable to assume a first state when an accessory is not coupled to the receiver and a second state when an accessory is coupled to the receiver.

The indicator may be one selected from amongst a mechanical indicator and an electrical indicator.

The indicator may for example be a mechanical button or an electrical lamp.

Other means for providing an indication that the accessory is correctly installed are also useful. For example, a distinctive audible sound such as a click when the adaptor becomes locked or any other suitable indication is also useful.

The locking means may be operable to be released by means of a key member.

Optionally the locking means is operable to be locked by means of the key member.

Optionally the receiver is configured to receive the key member to actuate the locking means. Optionally the adaptor is configured to receive the key member to actuate the locking means.

Advantageously the receiver may be further arranged to be looked to an adaptor by means of a second locking means.

Further advantageously the second locking means may be operable to be released by means of a second locking means key member.

Optionally the second locking means is operable to be locked by means of the second locking means key member.

Further optionally the receiver is configured to receive the second key member to actuate the second locking means. Optionally the adaptor is configured to receive the second key member to actuate the second locking means.

The second locking means may comprise a cam arrangement.

Advantageously the vehicle may comprise a seat having a plurality of receivers, the receivers being arranged to allow an accessory having a corresponding plurality of adaptors to be coupled to a back of the seat.

Further advantageously the seat may comprise three receivers arranged to allow an accessory to be coupled to a back of the seat.

It may he that the accessory comprises a plurality of adaptors arranged to couple to a corresponding plurality of receivers of a motor vehicle, it may be that the accessory comprises three adaptors arranged to couple to three corresponding receivers of a motor vehicle, if may further he that the accessory comprises a mount adapted to support at least one selected from amongst an entertainment module, a work surface and a child restraint.

In some arrangements one or more receivers may be sited in an under-bonnet area of the vehicle to support an accessory to facilitate maintenance. For example, to support a servicing tool, a repair tool an inspection lamp, a computing device, a workable or any other suitable accessory.

In a further aspect of the invention there is provided a motor vehicle having a cabin for one or more occupants, one of said one or more occupants being a driver of the vehicle, the cabin comprising: at least one anchor point for supporting an accessory, the anchor point comprising a receiver as described above. The receiver is suitable for cooperation with an adaptor as described above.

In a further aspect of the invention there is provided an accessory haying an adaptor as described above, the adaptor being suitable for cooperation with a receiver of an anchor point of a vehicle as described above.

In a further aspect of the invention there is provided a method of installing an accessory in a motor vehicle comprising: providing an accessory having an adaptor arranged to couple the accessory to a corresponding receiver of the motor vehicle thereby to support the accessory; and releasably locking the adaptor to the receiver by means of locking means whereby separation of the adaptor end receiver is resisted unless the locking means is first unlocked. The locking means comprises a cam arrangement, the cam arrangement comprising: a follower portion and a cam portion. The locking means further comprises a resilient member fixedly attached to the adaptor or the receiver. Releasably locking the adaptor to the receiver comprises engaging the follower portion with the cam portion such that the resilient member urges the follower portion against the cam portion.

In a further aspect of the invention there is provided a method of installing an accessory in a motor vehicle comprising: providing an accessory having an adaptor arranged to couple the accessory to a corresponding receiver of the motor vehicle thereby to support the accessory; and releasably locking the adaptor to the receiver by means of locking means whereby separation of the adaptor and receiver is resisted unless the locking means is first unlocked. The locking means comprises a cam arrangement. The receiver is coupled to an electrical power supply, and releasably locking the adaptor to the receiver comprises forming an electrical connection between the receiver and a corresponding electrical conductor of the adaptor, wherein electrical power may be supplied by the receiver to an accessory.

The method may further comprise the step of providing electrical power to the accessory by means of the receiver.

In a further aspect of the invention there is provided a fastening system, the fastening system comprising: at least one anchor point for supporting an accessory, the anchor point comprising a receiver for receiving a corresponding adaptor of an accessory; and an accessory having an adaptor arranged to couple the accessory to the receiver, the accessory and receiver comprising a locking means whereby the adaptor may be releasably locked to the receiver such that when in the coupled condition separation of the adaptor and the receiver is resisted unless the adaptor is first unlocked from the receiver. The locking means comprises a cam arrangement, the cam arrangement comprising: a follower portion and a cam portion, the cam portion being arranged to engage the follower portion when the adaptor is locked to the receiver. The locking means further comprises a resilient member fixedly attached to the adaptor or receiver, the resilient member being arranged to urge the follower portion against the cam portion when the cam portion engages the follower portion.

According to a further aspect of the invention there is provided a fastening system, the fastening system comprising: at least one anchor point for supporting an accessory, the anchor point comprising a receiver for receiving a corresponding adaptor of an accessory; and an accessory having an adaptor arranged to couple the accessory to the receiver, the accessory and receiver comprising a locking means whereby the adaptor may be releasably locked to the receiver such that when in the coupled condition separation of an adaptor and the receiver is resisted unless the adaptor is first unlocked from the receiver. The locking means comprises a cam arrangement. The receiver is coupled to an electrical power supply, the receiver being arranged to form an electrical connection to a corresponding electrical conductor of the adaptor when an adaptor is coupled to the receiver wherein electrical power may be supplied by the receiver to an accessory.

A fastening system as described above may be provided to a vehicle.

Embodiments of the invention have the advantage that an accessory requiring electrical power may he releasably but securely installed in a location such as a cabin of a vehicle without damaging or compromising an appearance of trim panels or trim features of the vehicle. This is because the receiver is already mounted in the vehicle ready to receive the adaptor when required. Furthermore, no separate power supply connection need be provided. Rather, the anchor point itself provides electrical power to the accessory by means of the adaptor.

Embodiments of the invention have the advantage that a risk that an accessory inadvertently becomes detached from the anchor point is substantially eliminated. Thus, a risk that mechanical vibrations or tugging on the accessory cause an accessory to be released is reduced.

Within the scope of this application if is envisaged that the various aspects, embodiments, examples, features and alternatives: set out in the preceding paragraphs, in the claims and/or in the following description and drawings may be taken independently or in any combination thereof. For example, features described in connection with one embodiment are applicable to all embodiments, except where there is incompatibility of features.

### BRIEF DESCRIPTION OF THE DRAWINGS

Embodiments of the invention will now be described, by way of example only, with reference to the accompanying figures in which:

FIG. 1 shows an accessory having an adaptor according to an embodiment of the invention for coupling to a receiver according to an embodiment of the invention:

FIG. 2 is a side view of a receiver according to an embodiment of the invention;

FIG. 3 shows (a) an accessory before being coupled to a receiver and (b) the accessory after being coupled to the receiver;

FIG. 4 is a cross-sectional view of an adaptor and a portion of a corresponding receiver according to a further embodiment of the invention having means for providing electrical power to the accessory;

FIG. 5 shows a rear portion of a vehicle interior according to an embodiment of the invention; and

FIG. 6 shows a rear floor portion of a vehicle interior according to the embodiment of FIG. 5.

### DETAILED DESCRIPTION

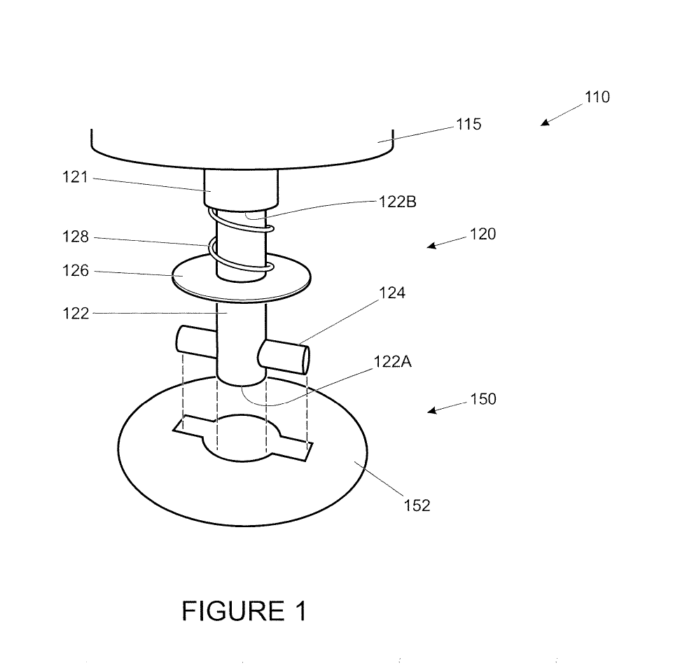

FIG. 1 shows an accessory 110 according to an embodiment of the present invention having an adaptor 120 arranged o be coupled to a receiver 150.

The adaptor 120 has a substantially cylindrical shaft member 122 extending from a base 121 of the adaptor 120, the shaft member 122 having a cross-pin (or T-bar) 124 extending radially from opposed sides thereof close to a first end 122A of the shaft member 122. The first end 122A is opposite a second end 1228 where the shaft member 122 meets the base 121.

An annular washer member 128 is provided around the shaft member 122. Between the washer member 128 and base 121 a spring member 128 is provided, the spring member 128 being arranged to urge the washer member 128 away from the base 121 if the washer member 126 is moved towards the base 121 against the action of the spring member 128. This feature promotes an increased stability of support of the accessory 110 by the receiver 150 in use as described below.

The receiver 150 comprises a face plate 152 having an aperture therein having a shape corresponding to that of a cross-sectional area of the shaft member 122 and cross-pin 124. The face plate 152 provides a guide to guide a user in correct insertion of the adaptor 120 into the receiver 150, as well as improving an aesthetic appearance of the receiver 150 as installed.

Behind the face plate 152 a cam receptacle 154 is provided through which the shaft 122 is arranged to be passed. A rear face 154R of the receptacle 154 is shaped to bear a pair of cam formations 156 at rotationally opposite positions of the rear face 154R, and a corresponding pair of stop formations 158.

The receiver 150 is arranged to allow the adaptor 120 to be inserted therein in an axial direction of the shaft member 122. Once the shaft member 122 has been inserted a sufficient distance the washer member 126 is urged against the spring member 128.

The shaft member 122 may then be rotated (in the embodiment shown the shaft member 122 is rotated in a clockwise direction) to lock the adaptor 120 to the receiver 150. As the shaft member 122 is rotated the cross-pin 124 slides along cam surface 156 drawing the shaft 122 former into the receiver 150. After rotation through substantially a quarter turn (around 90°) the cress-pin 124 reaches a distal end of the cam surface at which a cam shoulder 156S is provided. The shoulder 156S is shaped to allow the shaft member 122 to retract a short distance out of the receiver 150 as it slides along the shoulder 156S. Under the influence of the spring element 128 the shaft member 122 retracts until further rotation of the cross-pin 124 is constrained by the buffer element 158. The cross-pin 124 is then effectively trapped or ‘locked’ between the cam shoulder 156S and buffer element 158.

If is to be understood that tugging on the accessory 110 in an axial direction of the shaft 122 does not result in axial translation of the accessory 110 because the accessory 110 is trapped by abutment of the cross-pin 124 with the rear face 154R of the cam receptacle 154. Furthermore, rotation of the shaft 122 in en anticlockwise direction to release the accessory 110 is resisted by the cam shoulder 156S, locking the accessory to the receiver 150.

To release the accessory, sufficient torque must be applied to the shaft 122 in the anticlockwise direction. Axial pressure may also be placed on the shaft 122 to urge the shaft info the receiver 150 and ease removal of the adaptor 120 as the cross-pin 124 follows the shoulder 156S of the cam surface 158 before the shaft 122 is able to be rotated further and withdrawn.

It is to be understood that when the adaptor is in the locked condition the base 121 compresses the spring element 128 urging the washer member 126 against the face plate 152 of the receiver 150. This has the effect of increasing a stiffness of the coupling between the accessory 110 and receiver 150. Thus mechanical vibration of the receiver is less likely to result in relative movement between the accessory 110 and receiver 150, which may induce rattling, excess wear, damage to the accessory or increase a risk that inadvertent decoupling of the accessory and receiver takes place.

In the embodiment of FIG. 1 the adaptor 120 and receiver 150 are formed from a metallic material such as steel. Other materials are also useful.

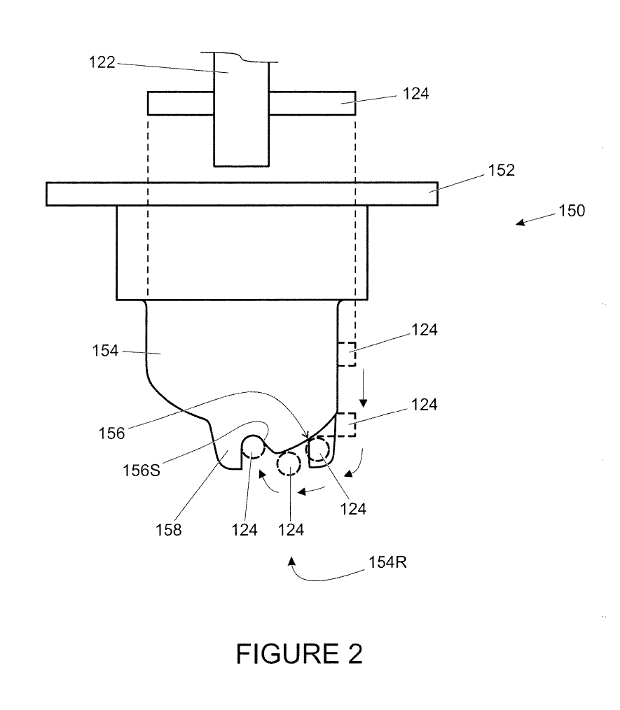

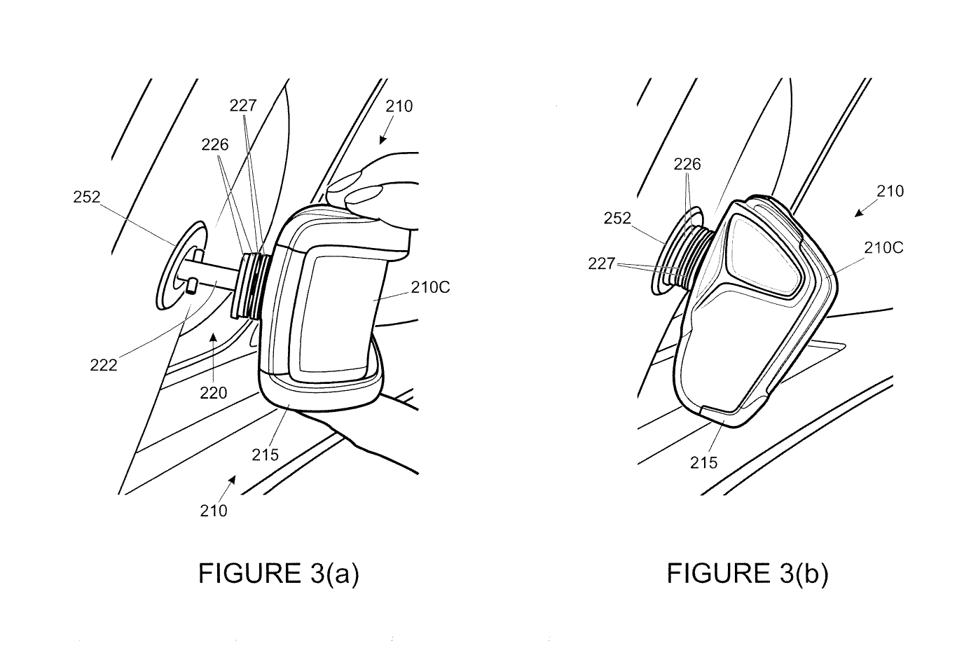

FIG. 3 shows an accessory 210 according to a further embodiment of the invention. Like features of the embodiment of FIG. 3 to that of FIG. 1 and FIG. 2 are provided with like reference signs prefixed numeral 2 instead of numeral 1.

The accessory 210 is configured to hold a mobile telephone and has a cradle 210C formed from an injection moulded plastics material for supporting the telephone.

A shaft 222 of the adaptor 220 of the accessory 210 has a pair of washer members 226 formed from a low-friction plastics material such as Teflon™ or the like instead of a spring member 128, a pair of resiliency flexible washer members 227 of frusto-conical shape are arranged with their apices in mutual abutment whereby axial pressure on washer members 226 towards the cradle 210C causes resilient compression of the resilient washer members 227.

Other arrangements for increasing a stiffness of the coupling between the accessory 210 and receiver 250 are also useful.

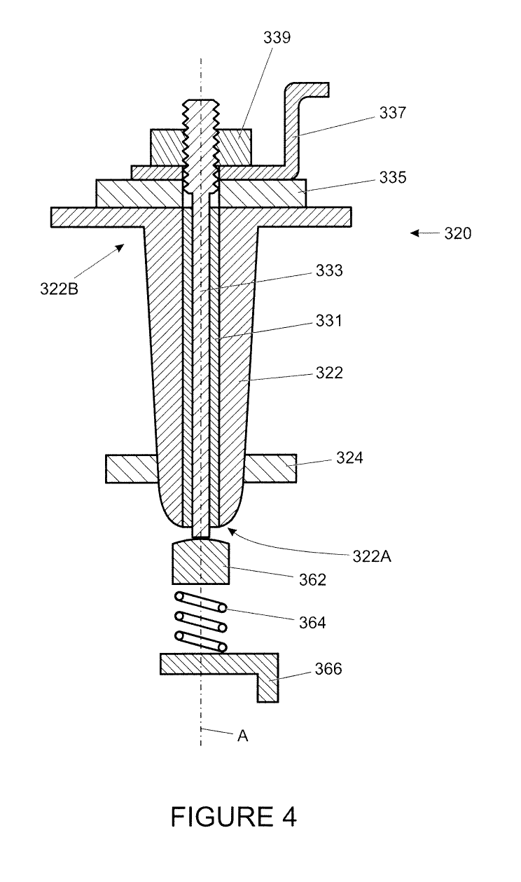

FIG. 4 shows a portion of an adaptor 320 arranged to allow electrical connection between a receiver and an accessory (not shown) of which the adaptor 320 is part.

In the embodiment of FIG. 4 the shaft 322 is foamed from a hollow steel tube. An electrical conductor core member 333 disposed therein parallel to a cylinder axis A of the shaft 322. An insulating liner 331 is provided between the shaft 322 and core member 333 to electrically isolate the core member 333 and shaft 322.

A tip of the core member 333 at a first end of the shaft 322 being a free end thereof protrudes axially from the shaft 322 to contact an electrical contact pad 362 of the receiver. The contact pad 382 is resiliently coupled to a conducting support portion 386 by means of a conducting spring element 364. The contact pad 362 is arranged such that when the adaptor 320 is coupled to the receiver the contact pad 362 is urged against the core member 333 whereby a reliable electrical connection may be formed between the adaptor 320 and receiver.

Embodiments of the invention have the advantage that an accessory may be coupled to a load-bearing anchor point such that a load-bearing connection is made between the accessory and the anchor point, whilst at the same time allowing electrical power to be supplied to the accessory via the same coupling. Thus, embodiments of the invention have the advantage that only a single connection is required to be made between an accessory and the vehicle in order to provide both structural support and electrical power to the accessory.

In some embodiments, receivers are provided in a vehicle that are arranged to support relatively low loads imposed by an accessory and to provide electrical power to the accessory. Such receivers may be located for example in door panels, seat backs, a dashboard, a centre console, or at any other suitable location. In some embodiments the receivers (and/or adaptors) are arranged to be frangible whereby excessive tugging on an accessory or impact on an accessory allows the accessory to become detached from the receiver.

In some embodiments receivers are provided in a vehicle in addition or instead that are able to support relatively high loads imposed by an accessory and not to provide electrical power although in some arrangements such receivers may also provide electrical power.

Such receivers may be located for example in a floor of the vehicle, a payload area behind one or more rearmost seats, in B, C or D pillars of the vehicle or any other suitable location.

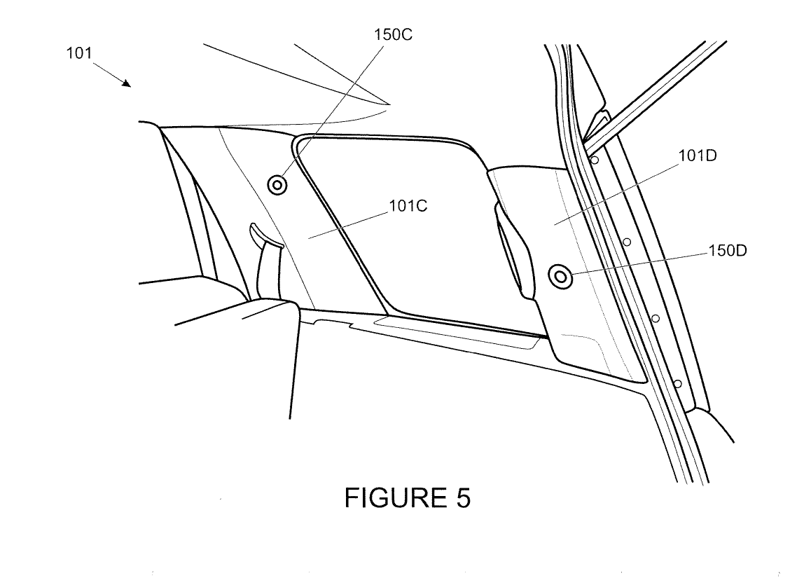

FIG. 5 shows a portion of an interior of a cabin 101 of a vehicle showing C and D pillars 101C, 101D of the vehicle respectively. A C-post receiver 150C is mounted to the C-post and available for a user to attach an accessory thereto whilst the D-post similarly has a receiver 150D mounted thereto.

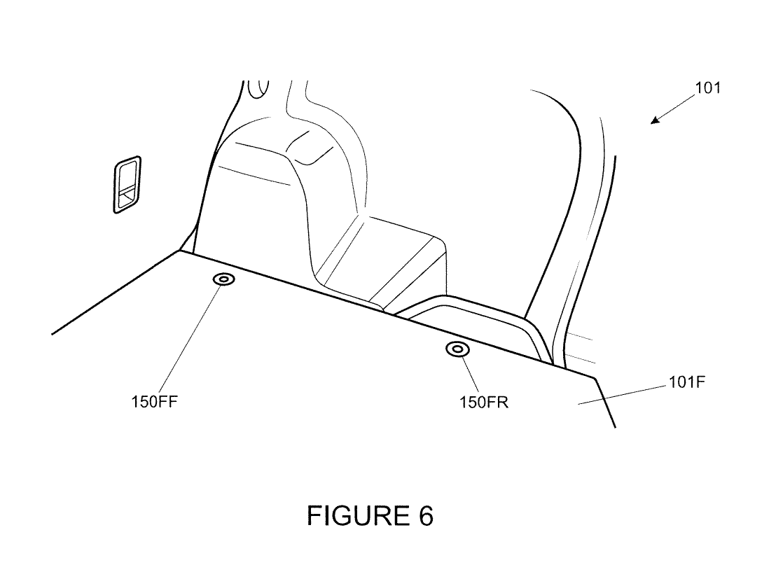

FIG. 6 shows a floor panel 101F of a boot area of the cabin 101. Forward and rearward floor panel receivers 150FF, 150FR are provided along left and right sides of the floor panel 101F.

In the embodiment shown the receivers 150C, 150D, 150FF, 150FR are heavy duty receivers arranged to bear relatively high loads associated with securing of a cargo in the boot area. Thus accessories bearing one or more D-loops, folding bails, cargo eyes or any other suitable load bearing accessory such as adaptors of a deg guard, tool box, other storage article or the like may be arranged to be connected thereto.

In some embodiments, a receiver arranged to provide an electrical connection may also receive an adaptor of an accessory not requiring electrical power, in order to prevent an electrical connection being made to such an adaptor the contact pad 382 of the receiver may be provided at a location such that the shaft 122, 222 of an adaptor 120, 220 arranged not to form an electrical connection to the receiver does not make contact to the contact pad 382. Thus, in adaptors that are arranged to make electrical connection the axial conductor 333 may be arranged to project a greater distance beyond the cross-pin 324 than the shaft 322 of an adaptor of a non-powered accessory, such that electrical connection may be made to the contact pad 362.

If is to be understood that other designs of adaptor are useful in addition to those described above. For example, other latch arrangements are also useful including latches of the spring-loaded bearing type.

It is to be understood that receivers and adaptors according to embodiments of the present invention by means of which electrical power is supplied to an accessory comprising the adaptor may be deployed in a range of applications including cargo bays of vans, trucks, transport containers, buildings, aircraft and marine vessels. Embodiments of the invention may also be useful in other applications.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A motor vehicle having a cabin for one or more occupants, the cabin comprising:
at least one anchor point for supporting an accessory, the anchor point comprising a receiver for receiving a corresponding adapter of an accessory; and
an accessory having an adaptor arranged to couple the accessory to the receiver,
the accessory and receiver comprising a locking means whereby the adaptor may be releasably locked to the receiver such that when in the coupled condition separation of the adaptor and the receiver is resisted unless the adaptor is first unlocked from the receiver,
the locking means comprising a cam arrangement, the cam arrangement comprising:
a follower portion; and
a cam portion, the cam portion being arranged to engage the follower portion when the adaptor is locked to the receiver,
the locking means further comprising a resilient member fixedly attached to the adaptor or the receiver, the resilient member being arranged to urge the follower portion against the cam portion when the cam portion engages the follower portion.

2. A motor vehicle having a cabin for one or more occupants, the cabin comprising:
at least one anchor point, for supporting an accessory, the anchor point comprising a receiver for receiving a corresponding adaptor of an accessory; and
an accessory having an adaptor arranged to couple the accessory to the receiver,
the accessory and receiver comprising a locking means whereby the adapter may be releasably locked to the receiver such that when in the coupled condition separation of the adaptor and the receiver is resisted unless the adaptor is first unlocked from the receiver,
the looking means comprising a cam arrangement,
wherein the receiver is coupled to an electrical power supply, the receiver being arranged to form an electrical connection to a corresponding electrical conductor of the adaptor when an adaptor is coupled to the receiver wherein electrical power may be supplied by the receiver to an accessory.

3. A motor vehicle having a cabin for one or more occupants, one of said one or more occupants being a driver of the vehicle, the cabin comprising:
at least one anchor point for supporting an accessory; the anchor point comprising a receiver for receiving a corresponding adaptor of an accessory; and
an accessory having an adaptor arranged to couple the accessory to the receiver,
the accessory and receiver comprising a locking means whereby the adaptor may be releasably locked to the receiver such that when in the coupled condition separation of the adaptor and the receiver is resisted unless the adaptor is first unlocked from the receiver,
the locking means comprising a cam arrangement.

4. A motor vehicle as claimed in claim 2 or claim 3, wherein the cam arrangement comprises:
a follower portion; and
a cam portion, the cam portion being arranged to engage the follower portion when the adaptor is locked to the receiver.

5. A vehicle as claimed in claim 4, wherein the locking means comprises a resilient member fixedly attached to the adaptor or the receiver, the resilient member being arranged to urge the follower portion against the cam portion when the cam portion engages the follower portion.

6. A vehicle as claimed in claim 1 or claim 3, or claims 4 or 5 as dependent on claim 3, wherein the receiver is coupled to an electrical power supply, the receiver being arranged to form an electrical connection to a corresponding electrical conductor of the adaptor when an adaptor is coupled to the receiver wherein electrical power may be supplied by the receiver to an accessory.

7. A vehicle as claimed in claim 1 or claim 2, or claims 4, 5 or 6 as dependent on claim 1 or claim 2, wherein one of said one or more occupants is a driver of the vehicle.

8. A vehicle as claimed in claim 1 or claim 6, or claims 8 or 7 as dependent on claim 1 or claim 5 wherein the resilient member is a helical spring.

9. A vehicle as claimed in any preceding claim wherein the cabin is provided with a plurality of receivers at different respective locations configured to accept like adaptors.

10. A vehicle as claimed in any preceding claim wherein the locking means of the receiver comprises a follower portion arranged to engage a corresponding cam portion of locking means of the adapter.

11. A vehicle as claimed in any of claims 1 to 9, wherein the locking moans of the adaptor comprises a follower portion arranged to engage a corresponding earn portion of a locking means of the receiver.

12. A vehicle as claimed in claim 1 or claim 4 or any of claims 5 to 11 as dependent upon claim 1 or claim 4, wherein the follower portion comprises a pin member.

13. A vehicle as claimed in claim 12, wherein the cam arrangement comprises a shaft member, the shaft member having one or more pin members protruding radially therefrom and arranged to engage the cam portion.

14. A vehicle as claimed in claim 13, wherein the follower portion comprises a pair of pin members arranged to protrude radially from opposed sides of the shaft member.

15. A vehicle as claimed in claim 13 or claim 14 wherein the shaft member comprises an outer conductor and an inner conductor in electrical isolation from the outer conductor whereby an electrical flow path may be provided.

16. A vehicle as claimed in claim 15 as dependent on claim 11, wherein the outer conductor is arranged to be electrically coupled to an electrical ground of the vehicle by means of the receiver.

17. A vehicle as claimed in claim 2 or claim 6, or any of claims 7 to 16 as dependent upon claim 2 or claim 6, wherein the receiver is arranged to provide an electrical flowpath to and from the adaptor by means of which electrical current may flow from a power source of the vehicle to an accessory and back to the power source.

18. A vehicle as claimed in any preceding claim wherein the receiver is electrically coupled to an electrical ground of the vehicle.

19. A vehicle as claimed in any preceding claim wherein the adaptor is provided with art electrical conductor arranged to form an electrical connection to a receiver whereby electrical power may be supplied by a receiver to an accessory.

20. A vehicle as claimed in claim 19 wherein the adaptor is arranged to provide an electrical flowpath by means of which electrical current may flow from a power source through a receiver to the accessory and back to a power source via the receiver.

21. A vehicle as claimed in any preceding claim comprising one or more receivers of a first type and one or more receivers of a second type, a receiver of the first type being arranged to couple to a corresponding adaptor of a first type, a receiver of the second type being arranged to be coupled to a corresponding adaptor of the second type.

22. A vehicle as claimed in claim 21 wherein a receiver of the first type is configured not to allow a coupling to be made to an adaptor of the second type.

23. A vehicle as claimed in claim 21 or claim 22 wherein a receiver of the first type has a first load capacity and a receiver of the second type has a second load capacity greater than the first.

24. A vehicle as claimed in any one of claims 21 to 23 depending through claim 2 or claim 6 wherein the one or more receivers of the first type are coupled to the electrical power supply.

25. A vehicle as claimed in any preceding claim wherein the receiver is provided with seal means whereby when the adaptor is coupled to the receiver a watertight seal may be provided therebetween.

26. A vehicle as claimed in any preceding claim wherein the adaptor is provided with seal means whereby when the adaptor is coupled to the receiver a watertight seal may be provided therebetween.

27. A vehicle as claimed any preceding claim wherein the receiver comprises visual indicator means, the indicator means being operable to assume a first state when an accessory is not coupled to the receiver and a second state when an accessory is coupled to the receiver.

28. A vehicle as claimed any preceding claim wherein the adaptor comprises visual indicator means, the indicator means being operable to assume a first state when the accessory is not coupled to the receiver and a second state when the accessory is coupled to the receiver.

29. A vehicle as claimed in claim 27 or claim 28 wherein the indicator means comprises one selected from amongst a mechanical indicator and an electrical indicator.

30. A vehicle as claimed in any preceding claim wherein the locking means is operable to be released by means of a key member.

31. A vehicle as claimed in claim 30 wherein the locking means is operable to be locked by means of the key member.

32. A vehicle as claimed in claim 30 or claim 31 wherein the receiver is configured to receive the key member to actuate the locking means.

33. A vehicle as claimed in claim 30, claim 31 or claim 32 wherein the adaptor is configured to receive the key member to actuate the locking means.

34. A vehicle as claimed in any preceding claim wherein the receiver is further arranged to be locked to the adaptor by means of a second locking means.

35. A vehicle as claimed in claim 34 wherein the second locking means is operable to be released by means of a second looking means key member.

36. A vehicle as claimed in claim 35 wherein the second locking means is operable to be looked by means of the second looking means key member.

37. A vehicle as claimed in claim 35 or claim 36 wherein the receiver is configured to receive the second key member to actuate the second locking means.

38. A vehicle as claimed in claim 35, claim 36 or claim 37 wherein the adaptor is configured to receive the second key member to actuate the second locking means.

39. A vehicle as claimed in any one of claims 35 to 38 wherein the second locking means comprises a cam arrangement.

40. A vehicle as claimed in any preceding claim comprising a seat having a plurality of receivers, the receivers being arranged to allow an accessory having a corresponding plurality of adaptors to be coupled to a back of the seat.

41. A vehicle as claimed in claim 40 wherein the seat comprises three receivers arranged to allow the accessory to be coupled thereto, the accessory having three corresponding adaptors.

42. A vehicle as claimed in any preceding claim, wherein the accessory comprises at least one selected from amongst a cup holder, a light source, a D-loop, a folding D-loop, a cargo eye, a video display mount, a mount for a handheld electrical device and a storage module.

43. A vehicle as claimed in any preceding claim, wherein the accessory comprises a plurality of adaptors arranged to couple to a corresponding plurality of receivers of a motor vehicle.

44. A vehicle as claimed in claim 43, wherein the accessory comprises three adaptors arranged to couple to three corresponding receivers of a motor vehicle.

45. A vehicle as claimed in claim 43 or claim 44, wherein the accessory comprises a mount adapted to support at least one selected from amongst an entertainment module, a work surface and a child restraint.

46. A motor vehicle having a cabin for one or more occupants, one of said one or more occupants being a driver of the vehicle, the cabin comprising:
at least one anchor point for supporting an accessory, the anchor point comprising a receiver as described in any preceding claim,
the receiver being suitable for cooperation with an adaptor of an accessory according to any preceding claim.

47. An accessory having an adaptor as described in any preceding claim, the adaptor being suitable for cooperation with a receiver of an anchor point of a vehicle according to any preceding claim.

48. A method of installing an accessory in a motor vehicle comprising:
providing an accessory having an adaptor arranged to couple the accessory to a corresponding receiver of an anchor point of the motor vehicle thereby to support the accessory; and
releasably locking the adaptor to the receiver by means of locking means whereby separation of the adaptor and receiver is resisted unless the locking means is first unlocked,
wherein the locking means comprises a cam arrangement, the cam arrangement comprising:
a follower portion; and
a cam portion,
the looking means further comprising a resilient member fixedly attached to the adaptor or the receiver,
and releasably locking the adaptor to the receiver comprises engaging the follower portion with the cam portion such that the resilient member urges me follower portion against the cam portion.

49. A method of installing an accessory in a motor vehicle comprising:
providing an accessory having an adaptor arranged to couple the accessory to a corresponding receiver of an anchor point of the motor vehicle thereby to support the accessory; and
releasably locking the adaptor to the receiver by means of locking means whereby separation of the adaptor and receiver is resisted unless the locking means is first unlocked,
wherein the locking means comprises a cam arrangement,
and wherein the receiver is coupled to an electrical power supply, and releasably locking the adaptor to the receiver comprises forming an electrical connection between the receiver and a corresponding electrical conductor of the adaptor, wherein electrical power may be supplied by the receiver to an accessory.

50. A method as claimed in claim 49 further comprising the step of providing electrical power to the accessory by means of the receiver.
